(19) United States
(12) Patent Application Publication
(10) Pub. No.: US 2003/0025844 A1
(43) Pub. Date: Feb. 6, 2003

(54) Projection type image display apparatus and projection lens apparatus

(76) Inventor: Shoji Suzuki, Tokyo (JP)

Correspondence Address: MORGAN & FINNEGAN, L.L.P., 345 PARK AVENUE, NEW YORK, NY, 10154, US

(21) Appl. No.: 10/202,266

(22) Filed: Jul. 24, 2002

(30) Foreign Application Priority Data
Aug. 1, 2001 (JP) 2001-233769

(51) Int. Cl. G02F 1/1335

(52) U.S. Cl. 349/5

(57) ABSTRACT

A projection type image display apparatus of the present invention comprises a plurality of image display devices which modulate a plurality of color beams, a color combination optical element which combines the color beams modulated by the plurality of image display devices, and projection optical system which projects light combined by the color combination optical element onto a projection surface. The projection optical system is provided with an adjustment lens. The adjustment lens is movable in an optical axis direction for focus adjustment at the time of adjustment of positioning of the image display devices with respect to the color combination optical element and fixed in the optical axis direction after the adjustment of positioning.

### BACKGROUND OF THE INVENTION

1. Field of the Invention

The present invention relates to a projection type image display apparatus such as a liquid crystal projector.

2. Description of the Related Art

Among liquid crystal projectors, there is a so-called “3-plate type” liquid crystal projector. This 3-plate type liquid crystal projector separates illumination light emitted from a light source lamp into three color beams of blue, green and red through a color separation optical system made up of a dichroic mirror, etc. and irradiates these three color beams onto a plurality of liquid crystal panels provided for their respective colors. Then, the three color beams modulated respectively by these liquid crystal panels are combined by a color combination optical system made up of a dichroic prism, etc. and magnified and projected onto a screen, etc. by a projection optical system.

In such a 3-plate type liquid crystal projector, adjustment of convergence (pixel matching) for fitting displayed images into a set size on the screen is performed by adjusting a total of 6 axes of the X-axis, Y-axis, Z-axis (focus), Θ (rotation) and inclinations around the X-axis and Y-axis.

There are a variety of configurations that allow such 6-axis convergence adjustment, and the recent mainstream among those configurations is a method whereby a prism side plate is attached to a dichroic prism, a panel side plate provided with a liquid crystal panel is subjected to a 6-axis adjustment with respect to the dichroic prism, and then the panel side plate is bonded and fixed to the prism side plate.

However, this configuration requires the projection optical system to have high precision flange back adjustment and it is difficult to guarantee its precision. Furthermore, with the tendency toward miniaturization of projectors, spaces (optical axis direction, X-direction, Y-direction and Θ-direction spaces) to satisfy the above-described fixing condition is limited in a projector.

However, the above-described conventional projector actually allows a flange back adjustment of projection optical system to a certain degree, makes a focus-balancing adjustment between the telescopic side and wide-angle side of zoom of the projection optical system as a single unit and takes necessary steps for focus-balancing on the telescope side and wide-angle side of the zoom lens by using a reference green (Gch) liquid crystal panel during a focus adjustment in a convergence adjustment.

Furthermore, as described above, the spaces (optical axis (Z-axis) direction, X-direction, Y-direction and Θ-direction spaces) to satisfy the above-described fixing condition is limited, and especially it is necessary to accommodate the space in the optical axis direction between the prism side plate bonded to the dichroic prism and the panel side plate to which the liquid crystal panel is attached within a predetermined allowable range because of the fixing condition.

However, it is difficult for the conventional projector to satisfy this condition because of tolerance of components (projection optical system, dichroic prism, prism pedestal, prism side plate and panel side plate).

Here, if the focus is not set within a predetermined allowable range during a convergence adjustment, it is impossible to detect the best focus position or fix the image display device to the prism. For this reason, the prior art takes much time for adjustments and requires high precision for the above-described components.

### SUMMARY OF THE INVENTION

It is an object of the present invention to provide a projection type image display apparatus capable of making it easier to adjust flange back of the projection optical system and relaxing the accuracy of components.

To attain the above-described object, the projection type image display apparatus of the present invention is constructed as follows. That is, the projection type image display apparatus of the present invention comprises a plurality of image display devices which modulate a plurality of color beams, a color combination optical element which combines color beams modulated by the plurality of image display devices and a projection optical system which projects light combined by the color combination optical element onto a projection surface. The projection optical system is provided with an adjustment lens, which is movable in the optical axis direction for focus adjustment at the time of adjustment of positioning of the image display devices with respect to the color combination optical element and fixed in the optical axis direction after the adjustment of positioning.

In the projection type image display apparatus, of the projection optical system, the adjustment lens is preferably placed closest to the color combination optical element.

Furthermore, in order to attain the above-described object, the projection type image display apparatus of the present invention is constructed as follows. That is, the projection type image display apparatus of the present invention comprises a plurality of image display devices which modulate a plurality of color beams, a color combination optical element which combines color beams modulated by the plurality of image display devices and a projection optical system which projects light combined by the color combination optical element onto a projection surface. Furthermore, an adjustment lens is provided between the projection optical system and the color combination optical element and the adjustment lens is movable in the optical axis direction for focus adjustment at the time of adjustment of positioning of the image display devices with respect to the color combination optical element and fixed in the optical axis direction after the adjustment of positioning.

In the above-described projection type image display apparatus, it is preferable to fix the first holding member which holds the projection optical system to the fixing member which supports the color combination optical element, insert and hold the second holding member which holds the adjustment lens in the first holding member so that the eccentric component of the adjustment lens with respect to the projection optical system is minimized to guarantee the optical performance.

Furthermore, when the projection optical system is made detachable or replaceable, it is preferable to make the optical performance of the adjustment lens applicable to any of a plurality of types of the projection optical system, that is, optical performance capable of maintaining required projection resolution.

Furthermore, it is preferable to make it easier to detect the best focus position by setting the sensitivity to the optical performance other than focus adjustment of the adjustment lens (extremely) lower than the sensitivity to focus adjustment thereof.

A detailed configuration of the projection type image display apparatus and projection lens apparatus of the invention, the above and other objects and features of the invention will be apparent from the embodiments, described below.

### BRIEF DESCRIPTION OF THE DRAWINGS

FIG. 1 is plan view of a color combination/projection unit of a projection type image display apparatus of an embodiment of the present invention;

FIG. 2 is a side view of the color combination/projection unit shown in FIG. 1 viewed from an arrow A in FIG. 1;

FIG. 3 is a side view of the color combination/projection unit shown in FIG. 1 viewed from an arrow B in FIG. 1;

FIG. 4 is a block diagram of the projection type image display apparatus incorporating the color combination/projection unit shown in FIG. 1; and

FIG. 5 is a plan view and side view of the color combination/projection unit according to another embodiment of the present invention.

### DETAILED DESCRIPTION OF THE PREFERRED EMBODIMENTS

Hereinafter, preferred embodiments of the invention will be described in detail with reference to the drawings.

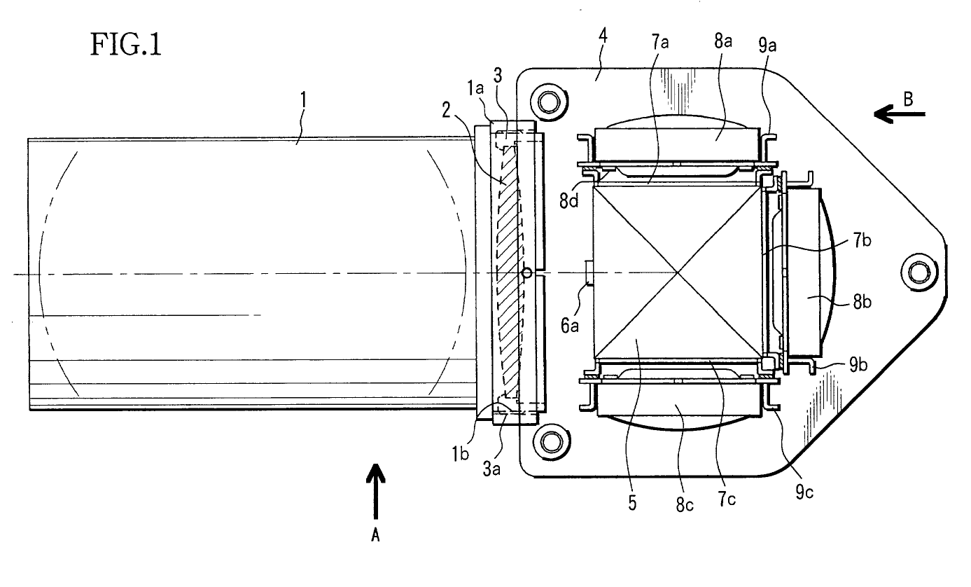

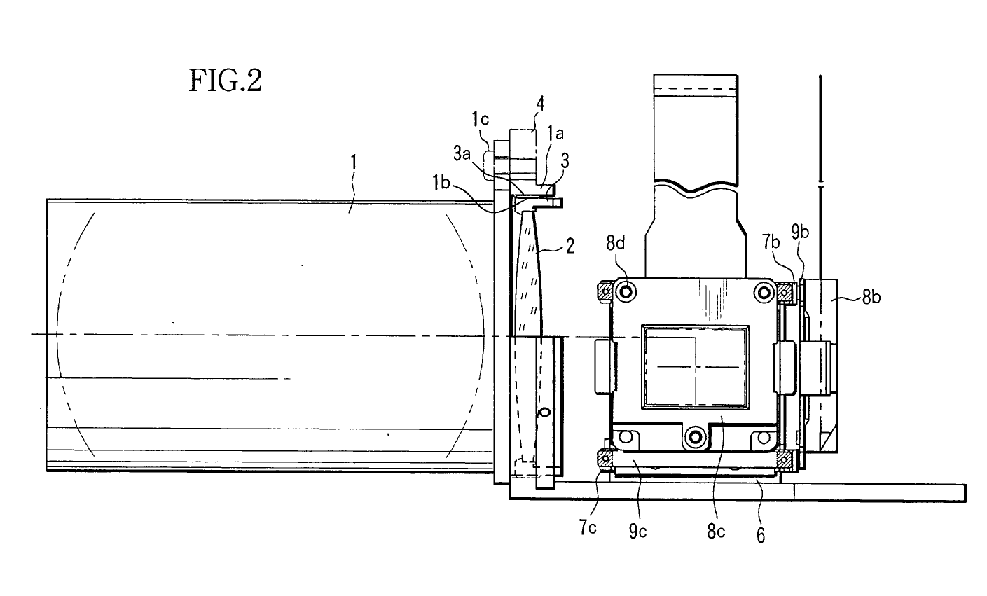

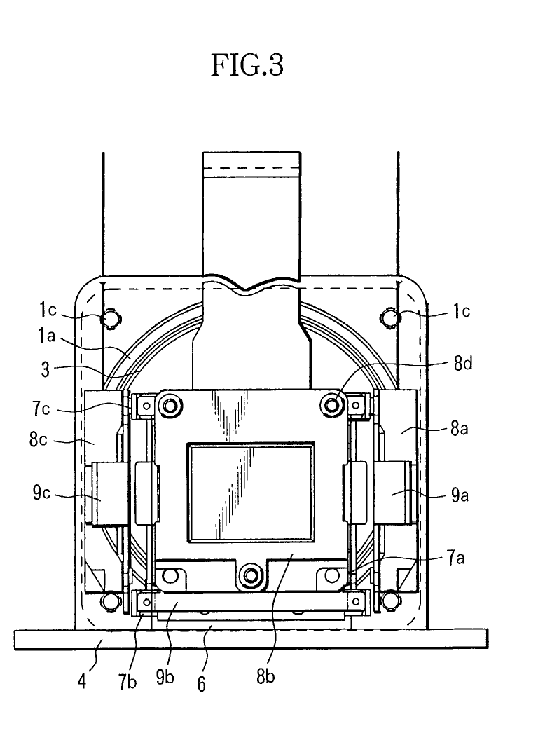

FIG. 1 to FIG. 3 show a configuration of a unit (hereinafter referred to as “color combination/projection unit”) made up of a color combination optical system and projection lens apparatus of a projection type image display apparatus which is an embodiment of the present invention. FIG. 1 is a plan view of the above-described color combination/projection unit, FIG. 2 is a side view of the above-described color combination/projection unit viewed from the direction indicated by an arrow A in FIG. 1, and FIG. 3 is a view of the above-described color combination/projection unit viewed from the direction indicated by an arrow B in FIG. 1 (liquid crystal panel side).

In these drawings, reference numeral 1 denotes projection lens apparatus, which project light of an image combined by a color combination prism 5, which will be described later, onto a screen (not shown). A plurality of lenses (zoom lens and focus lens, etc.) making up a projection optical system in the projection lens apparatus 1 are held in a first holding lens-barrel 1a.

Reference numeral 2 denotes a focus adjustment lens provided aside from the focus lens in the projection lens apparatus 1 and held by a second holding lens-barrel 3. This second holding lens-barrel 3 is inserted in a screw section 1b formed closest to the plane of incidence of the image light of the first holding lens-barrel 1a, that is, closest to the color combination prism 5 of the projection lens apparatus 1 and engaged with this screw section 1b. The second holding lens-barrel 3 (that is, focus adjustment lens 2) can be moved toward the optical axis through actions of the screw sections 1b and 3b by turning the second holding lens-barrel 3 around the optical axis. The second holding lens-barrel 3 has a configuration applicable not only to a standard lens but also to a replacement lens engaged by means of screws.

Furthermore, the optical power (the reciprocal of index of refraction) of the focus adjustment lens 2 is smaller than the optical power of lenses of the projection optical system and is set, for example, to within 1/3.5 times (within zoom ratio×1.4).

Furthermore, optical aberration of the focus adjustment lens 2 is set to sensitivity lower than other lenses (projection optical system) making up the projection lens apparatus 1 and especially a variation of the image surface is set to ≈0 versus a variation of the optical axis of 0.1 mm.

Reference numeral 4 denotes an L-figured base as a fixing member, which holds a flange section of the projection lens apparatus 1, and a prism unit, which will be described later.

Furthermore, reference numeral 5 denotes a color combination prism and a so-called cross dichroic prism is used in this embodiment. This color combination prism 5 touches on and is bonded to a positioning section 6a of a prism pedestal 6 fixed to the L-figured base 4.

Reference numerals 7a, 7b and 7c denote panel holding bases and are positioned on and bonded to areas other than the optically effective areas on the planes of incidence of blue, green and red light beams in the color combination prism 5. These panel holding bases 7a, 7b and 7c are provided with apertures corresponding to the optically effective areas on the planes of incidence of the color combination prism 5.

Reference numerals 8a, 8b and 8c denote liquid crystal panels (image display devices) provided for the above-described respective colors. A blue (B) channel liquid crystal panel 8a, a green (G) channel liquid crystal panel 8b and a red (R) channel liquid crystal panel 8c are fixed to panel holding plates 9a, 9b and 9c respectively by means of screws.

By the way, the panel holding plates 9a to 9c are positioned to the panel holding bases 7a to 7c respectively and bonded/fixed to protruded sections provided in the four corners of the panel holding bases 7a to 7c (the hatching areas in FIG. 1 correspond to the bonded sections).

Then, an assembling/adjusting procedure of the color combination/projection unit in the above-described configuration will be explained.

First, the second holding lens-barrel 3 incorporating the focus adjustment lens 2 is fitted into the L-figured base 4 and temporarily fixed and the prism unit (assembly of the color combination prism 5, prism pedestal 6, panel holding bases 7a, 7b and 7c, and panel holding plates 9a, 9b and 9c) is positioned to the prism pedestal 6 and then fixed to the L-figured base 4.

Then, the projection lens apparatus 1 whose optical performance has been guaranteed are attached to the L-figured base 4 using screw 1c.

Then, the convergence adjusting procedure will be explained.

First, before adjusting convergence, the focus position of the projection lens apparatus 1 is set to a reference position and the liquid crystal panels 8a, 8b and 8c which are chucked to adjustment devices (not shown) are set to reference positions.

In this condition, the second holding lens-barrel 3 with the built-in focus adjustment lens 2 is turned around the optical axis with respect to the first holding lens-barrel 1a and moved in the optical axis direction by actions of the screw sections 1a and 3a, focus-balancing on the telescopic side and wide-angle side of zoom is performed with respect to the liquid crystal panel 8b of the reference Gch to detect the best focus position. In this case, it is not necessary to carry out focus-balancing between the telescopic side and wide-angle side of zoom of the projection lens apparatus 1 and focus adjustment with high accuracy.

When only the projection lens apparatus 1 are adjusted, high accuracy is required because assembly/adjustment errors of the components of the prism unit and measurement/adjustment errors of the projection lens apparatus 1 are accumulated together. On the other hand, in this embodiment, the color combination optical system and projection lens apparatus 1 are assembled into a unit and then adjusted, and therefore the above-described accumulated errors are eliminated.

Furthermore, this embodiment minimizes the optical power of the focus adjustment lens 2 so that the sensitivity (aberration sensitivity, etc.) to the optical performance other than focus adjustment of this focus adjustment lens 2 is much lower than the sensitivity to focus adjustment.

Then, after confirming that the focus positions of the Bch and Rch with respect to the liquid crystal panels 8a and 8c are satisfactory, the second holding lens-barrel 3 is fixed to the first holding lens-barrel 1a by means of set screws (not shown).

Then, as a convergence adjustment, the position and posture of the liquid crystal panel 8b of the Gch are adjusted so that the X-axis, Y-axis and Θ (rotation) match the size set on a screen (not shown) which is the projection surface. Then, for the liquid crystal panel 8c of the Rch, the X-axis, Y-axis, and Θ, and inclination of the X-axis and inclination of the Y-axis with respect to reference Gch are adjusted so that pixels are fitted within an allowable range.

An adjustment similar to that for the Rch is also performed for the liquid crystal panel 8a of the Bch so that pixels are fitted within an allowable range.

Finally, pixel matching and focus positions of the Rch and Bch with respect to the reference Gch are confirmed and if both are within an allowable range, the liquid crystal panels 8a, 8b and 8c are fixed to the panel holding plates 9a, 9b and 9c by means of three screws (8d) and this completes assembly and adjustments of the color combination/projection unit.

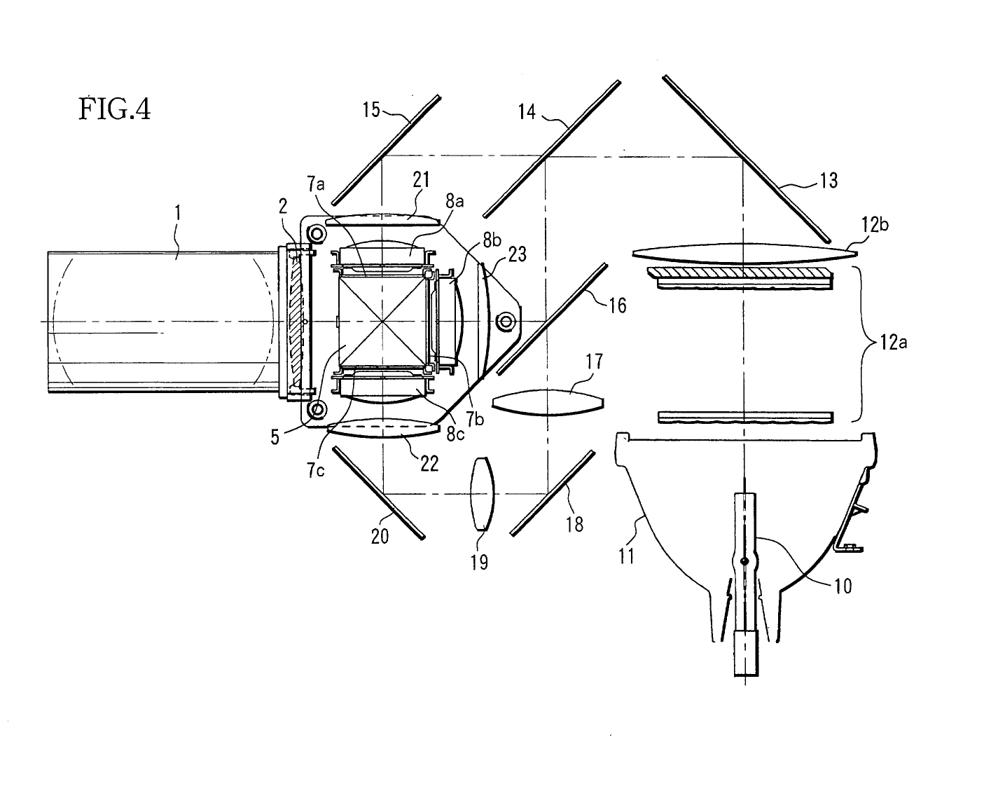

FIG. 4 shows a configuration of a projection type image display apparatus incorporating the above-described color combination/projection unit.

Reference numeral 10 denotes an illumination light source, 11 denotes a reflector that reflects forward the light emitted sideward and backward from the illumination light source 10. Reference numeral 12a denotes a fly-eye lens unit to intensify light from the illumination light source 10 and reflector 11 substantially uniformly and 12b denotes a condenser lens. Reference numeral 13 denotes a reflecting mirror.

Reference numeral 14 denotes a first dichroic mirror that allows only the blue wavelength area component of the illumination light reflected by the reflecting mirror 13 to penetrate and reflects the green and red wavelength area components, 15 denotes a reflecting mirror that guides the blue wavelength area component of the light which has penetrated the first dichroic mirror 14 to the Bch liquid crystal panel 8a through the field lens 21.

Reference numeral 16 denotes a second dichroic mirror that reflects the green wavelength area component out of the green and red wavelength area components of the light reflected by the first dichroic mirror 14 and allows the red wavelength area component to penetrate. The light of the green wavelength area component reflected by this second dichroic mirror 16 is guided through the field lens 23 to the Gch liquid crystal panel 8b.

On the other hand, the light of the red wavelength area component that has penetrated the second dichroic mirror 16 is guided through the condensing lens 17, reflecting mirror 18, condensing lens 19, reflecting mirror 20 and field lens 22 to the Rch liquid crystal panel 8c.

The light beams of the color wavelength areas incident upon the respective liquid crystal panels 8a, 8b and 8c are modulated while penetrating these liquid crystal panels.

By the way, the liquid crystal panels 8a, 8b and 8c are driven by drive signals output from a control circuit (not shown) according to image signals supplied from a personal computer or video (or DVD) player, etc. (not shown), and forms image light by modulating the incident light.

The modulated light beams (image light) of the respective wavelength areas emitted from the liquid crystal panels 8a, 8b and 8c are incident upon the color combination prism 5, combined by actions of dichroic films in the color combination prism 5 and emitted from the color combination prism 5 to the projection lens apparatus 1. The image light incident upon the projection lens apparatus 1 is magnified and projected onto the screen to display an image.

At this time, since the aforementioned convergence adjustment has been performed correctly by the color combination/projection unit, a satisfactory full-color image with no color drift is displayed on the screen.

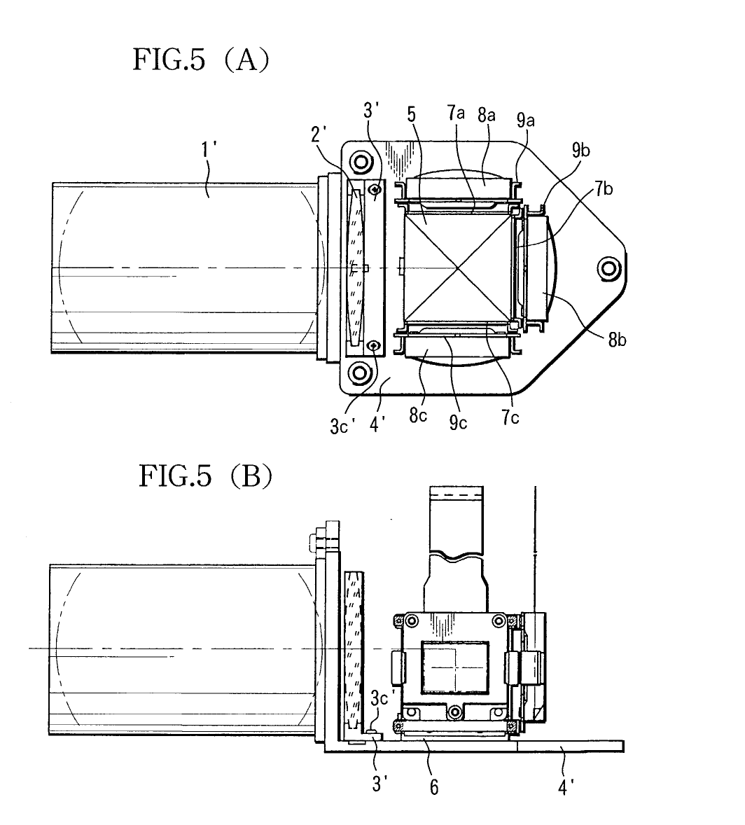

FIG. 5(A) and FIG. 5(B) show a configuration of a color combination/projection unit of a projection type image display apparatus, which is another embodiment of the present invention. FIG. 5(A) is a plan view of the above-described image projection unit and FIG. 5(B) is a side view of the above-described image projection unit. Furthermore, the components in this embodiment common to those in the foregoing embodiment are assigned the same reference numerals and explanations thereof will be omitted.

The above-described embodiment has described the case where the second holding lens-barrel 3 which holds the focus adjustment lens 2 is engaged with the first holding lens-barrel 1a that holds the lenses of the projection lens apparatus 1 and the focus adjustment lens 2 is provided as the component of the projection lens apparatus 1. On the other hand, this embodiment is constructed in such a way as to provide a focus adjustment lens 2′ aside from the projection lens apparatus 1′, provide a guide mechanism (groove or key, etc.) between the holding lens-barrel 3′ that holds this focus adjustment lens 2′ and an L-figured base 4′ in such a way that the holding lens-barrel 3′ is movable in the optical axis direction with respect to the L-figured base 4′ within a predetermined range and fix the holding lens-barrel 3′ to the L-figured base 4′ by means of set screws 3c′.

In the color combination/projection unit of this embodiment, the holding lens-barrel 3′ is slid in the optical axis direction with respect to the L-figured base 4′, for detecting the best focus position with respect to the liquid crystal panel 8b of the reference Gch. After confirming that the focus position with respect to the Bch and Rch liquid crystal panels 8a and 8c is satisfactory, the holding lens-barrel 3′ is fixed to the L-figured base 4′ by means of set screws (not shown). The subsequent assembling and adjusting procedures are the same as those in the above-described embodiment.

When a plurality of types of projection lens apparatus are detachable or replaceable in the color combination/projection unit explained in the above-described embodiments, the optical performance of the focus adjustment lens may be made applicable to any of the plurality of these projection lens apparatus, that is, capable of maintaining required projection resolution.

As explained above, according to the above-described embodiments, since the focus adjustment lens, which can be moved in the optical axis direction during adjustment of positioning of the image display device to adjust focus, is placed inside the projection lens apparatus 1 or between the projection lens apparatus 1′ and color combination prism 5, focus-balancing between the telescopic side and wide-angle side of zoom with respect to the reference Gch liquid crystal panel 8a and adjusting focus thereto can be performed before adjusting convergence. Therefore, it is possible to prevent a failure to detect the best focus position within the allowable range during a convergence adjustment or prevent a failure of the liquid crystal panels to be fixed to the color combination prism 5 and thereby improve the efficiency of convergence adjustment.

Furthermore, in the above-described embodiments, the need to carry out focus-balancing between the telescopic side and wide-angle side of zoom of the projection lens apparatus 1 and 1′ and focus adjustment with high accuracy can be eliminated, and the accuracy of components of the color combination/projection unit also can be relax.

Moreover, in the above-described embodiments, since convergence adjustment singly in the color combination/projection unit can be performed and incorporation of the unit into an optical engine (unit including a illumination light source, a color separation optical system and combination optical system) after the convergence adjustment, the efficiency of assembly of the projection type image display apparatus can be improved.

While preferred embodiments have been described, it is to be understood that modification and variation of the present invention may be made without departing from the sprit or scope of the following claims.

What is claimed is:

1. A projection type image display apparatus comprising:
a plurality of image display devices which modulate a plurality of color beams respectively;
a color combination optical element which combines the color beams modulated by said plurality of image display devices; and
a projection optical system which projects light combined by said color combination optical element onto a projection surface,
wherein said projection optical system is provided with an adjustment lens, said adjustment lens is movable in the optical axis direction for focus adjustment at the time of adjustment of positioning of said image display devices with respect to said color combination optical element, and fixed in the optical axis direction after said adjustment of positioning.

2. The projection type image display apparatus according to claim 1, wherein of said projection optical system, said adjustment lens is placed closest to the color combination optical element.

3. The projection type image display apparatus according to claim 1, wherein optical power φ1 of said adjustment lens is smaller than optical power φ of lenses other than said adjustment lens of said projection optical system.

4. The projection type image display apparatus according to claim 3, wherein the following condition is satisfied:
φ1:φ≦1:3.5

5. The projection type image display apparatus according to claim 1, further comprising:
a fixing member which supports said color combination optical element;
a first holding member which holds said projection optical system and is fixed to said fixing member; and
a second holding member which holds said adjustment lens and is held being inserted in said first holding member.

6. The projection type image display apparatus according to claim 1, wherein said projection optical system is detachable or replaceable and said adjustment lens has optical performance applicable to a plurality of types of said projection optical system.

7. The projection type image display apparatus according to claim 1, wherein sensitivity to the optical performance other than focus adjustment of said adjustment lens is lower than the sensitivity to focus adjustment of said adjustment lens.

8. The projection type image display apparatus according to claim 1, further comprising:
a color separation illumination optical system which separates illumination light from a light source into a plurality of color beams and irradiates the color beams onto said plurality of image display devices.

9. A projection type image display apparatus comprising:
a plurality of image display devices which modulate a plurality of color beams;
a color combination optical element which combines color beams modulated by said plurality of image display devices; and
a projection optical system which projects light combined by said color combination optical element onto a projection surface,
wherein an adjustment lens is provided between said projection optical system and said color combination optical element, and
said adjustment lens is movable in the optical axis direction for focus adjustment at the time of adjustment of positioning of said image display devices with respect to said color combination optical element and fixed in the optical axis direction after said adjustment of positioning.

10. The projection type image display apparatus according to claim 9, wherein optical power φ1 of said adjustment lens is smaller than optical power φ1 of said projection optical system.

11. The projection type image display apparatus according to claim 10, wherein the following condition is satisfied:
φ1:φ≦1:3.5

12. The projection type image display apparatus according to claim 9, further comprising:
a fixing member which supports said color combination optical element;
a first holding member which holds said projection optical system and is fixed to said fixing member; and
a second holding member which holds said adjustment lens and is held being inserted in said first holding member.

13. The projection type image display apparatus according to claim 9, wherein said projection optical system is detachable or replaceable and said adjustment lens has optical performance applicable to a plurality of types of said projection optical system.

14. The projection type image display apparatus according to claim 9, wherein sensitivity to the optical performance other than focus adjustment of said adjustment lens is lower than the sensitivity to focus adjustment of said adjustment lens.

15. The projection type image display apparatus according to claim 9, further comprising a color separation illumination optical system which separates illumination light from a light source into a plurality of color beams and irradiates the color beams onto said plurality of image display devices.

16. A projection lens apparatus used for a projection type image display apparatus provided with a plurality of image display devices which modulate a plurality of color beams and a color combination optical element which combines the color beams modulated by said plurality of image display devices, comprising:
a projection optical system which projects light combined by said color combination optical element onto a projection surface; and
an adjustment lens that is movable in the optical axis direction for focus adjustment at the time of adjustment of positioning of image display devices with respect to the color combination optical element and fixed in the optical axis direction after said adjustment positioning.

17. The projection lens apparatus according to claim 16, wherein said adjustment lens is placed toward the color combination optical element rather than said projection optical system.
